(19) United States
(12) Patent Application Publication
(10) Pub. No.: US 2012/0305702 A1
(43) Pub. Date: Dec. 6, 2012

(54) DEVICE FOR ROTATIONALLY COUPLING A RING WITH A WHEEL AND AIRCRAFT LANDING GEAR EQUIPPED WITH SUCH A DEVICE

(75) Inventors: Daniel BUCHETON, LE CHESNAY (FR); Sébastien REMOND, RAMBOUILLET (FR); Gilles ELUARD, ACHERES (FR)

(73) Assignee: MESSIER-BUGATTI-DOWTY, VELIZY VILLACOUBLAY (FR)

(21) Appl. No.: 13/475,128

(22) Filed: May 18, 2012

(30) Foreign Application Priority Data
May 20, 2011 (FR) FR 11 54445

(51) Int. Cl. B64C 35/00

(52) U.S. Cl. 244/101

(57) ABSTRACT

The invention relates to a device (32) for rotationally coupling a wheel (10) with a ring (31) for driving the wheel (10) mounted so as to rotate coaxially with the wheel (10).

According to the invention the device (32) comprises a plurality of connecting members (60) each extending in a direction contained in a plane perpendicular to the axis of rotation and forming an angle with a radial direction, the connecting members (60) being pivotably mounted on the one hand on the wheel (10) and on the other hand on the ring (31).

The invention relates to a device for rotationally coupling a ring with a wheel and to aircraft landing gear equipped with such a device.

### BACKGROUND OF THE INVENTION

In order to reduce fuel consumption as well as the noise levels and pollution produced by the operation of jet engines on the ground, it has been proposed to motorize the wheels of the aircraft so as to allow it to move in an airport zone without the aid of its jet engines.

Thus, the landing gear of an aircraft comprising a leg hinged at a first end with the aircraft and having, mounted on a second end, a wheel or wheel train resting on the ground is also provided with a member for driving the wheel or taxiing motor so as to move the aircraft when it is on the ground, for example between its parking location and the take-off runway.

During landing and take-off the landing gear is subject to severe stressing which causes deformation of the wheel rim and displacement of its axis of rotation with respect to the landing gear.

Coupling means are thus arranged between the drive member and the wheel in order to absorb the deformation and the movements of the wheel rim in relation to the drive member. For example, in the railway sector, helical spring transmissions made by Westinghouse or Sécheron are known. However, these coupling means are heavy and unsuitable for aircraft.

It is also known from document FR339382 a transmission sleeve involving three compressible linkages articulated at both ends and transmitting movement from a first rotating plate secured to a first shaft to a second plate secured to a second shaft. Those linkages create an elastic link between the two shafts, able to absorb misalignment between first and second shafts.

### OBJECT OF THE INVENTION

The object of the invention is to propose coupling means which are able to absorb major deformation of the rim and/or displacement of the axis of rotation of the wheel.

### BRIEF DESCRIPTION OF THE INVENTION

In order to achieve this object, according to the invention it has been proposed to provide a device for rotationally coupling a wheel with a wheel drive ring mounted so as to rotate coaxially with the wheel, the device comprising a plurality of connecting members pivotably mounted on the rim on the one hand and on the ring on the other hand and each extending in a direction defined by the centre of the pivots and contained in a plane perpendicular to the axis of rotation so as to form an angle with a radial direction.

Thus, the axis of rotation of the wheel may allow an angular displacement in relation to the axis of rotation of the drive ring, while transmitting the rotational movement.

Advantageously, each connecting member has a length which varies when subject to a force acting on the connecting member in opposition to an internal dissipating force.

The variable length of the connecting member results in the possibility for greater degrees of freedom between the ring and the wheel.

The device according to the invention is particularly suitable for landing gear comprising at least one axle for receiving at least one wheel associated with a wheel drive member comprising a ring mounted so as to rotate coaxially with the wheel and connected to controlled means for rotational driving thereof.

### BRIEF DESCRIPTION OF THE DRAWINGS

The invention will be understood more clearly in the light of the description illustrated by the accompanying figures in which:

FIG. 1 is a partially sectioned side view of landing gear comprising two wheel and brake assemblies, only one of which is shown, the figure being provided by way of a non-limiting example of the context of the invention;

FIG. 2 is a view, on a larger scale, of the rotational drive member equipping the wheel and brake assembly according to FIG. 1 and comprising a coupling device according to the invention;

FIG. 3 is a cross-sectional view along the line III-III of FIG. 2 of the coupling device according to the invention shown in FIG. 2;

FIGS. 4, 5 and 6 are longitudinally sectioned views of a telescopic linkage used within the scope of the invention, in the rest condition, fully compressed condition and fully extended condition, respectively.

### DETAILED DESCRIPTION OF THE INVENTION

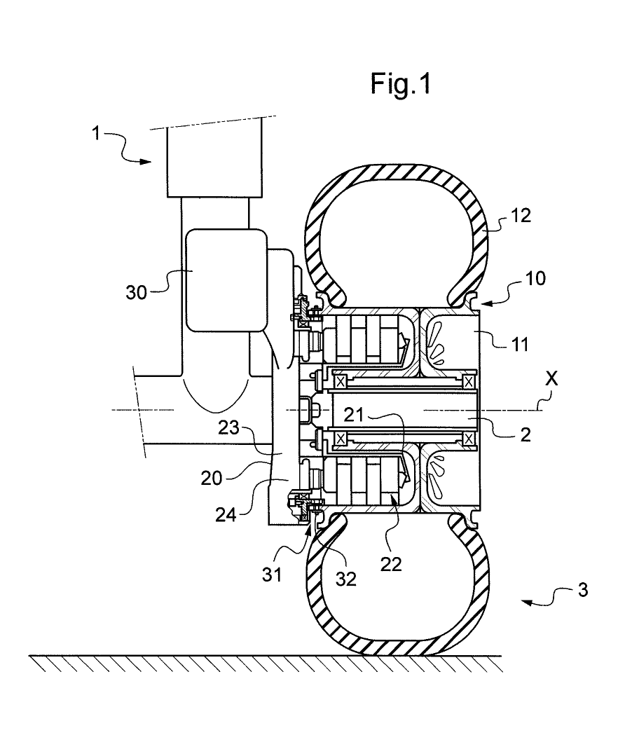

FIG. 1 shows landing gear 1 of the known type provided by way of example in order to illustrate the context of the invention. The landing gear comprises a bottom part with an axle 2 intended to receive two wheel and brake assemblies 3 on either side of the landing gear. Only one of these assemblies is shown here.

Each assembly comprises:
a wheel 10 with a rim 11 (here consisting of two half-rims) which receives a tyre 12, mounted so as to rotate on the axle 2 by means of rolling bearings about an axis of rotation X;
a brake 20 comprising a torsion tube 21 bolted onto the landing gear so as to be rotationally fixed, discs 22 extending between the torsion tube 21 and the rim 11 so as to be rotationally locked alternately with the rim 11 and the torsion tube 21, an actuator holder 23 integral with the torsion tube 21 and housing the braking actuators 24, in this case hydraulic actuators each comprising a piston mounted so as to slide inside recesses of the actuator holder 23. The above is of course not limiting and the actuators may be of the electrical type incorporated, as in the case here, in the structure of the actuator holder or able to be singly disassembled.

The actuator holder 23 has a rotational drive member, in this case an electric gear motor 30 which rotationally drives a drive ring 31 mounted around the actuator holder 23 so as to rotate on the latter about the axis of rotation X of the wheel 10.

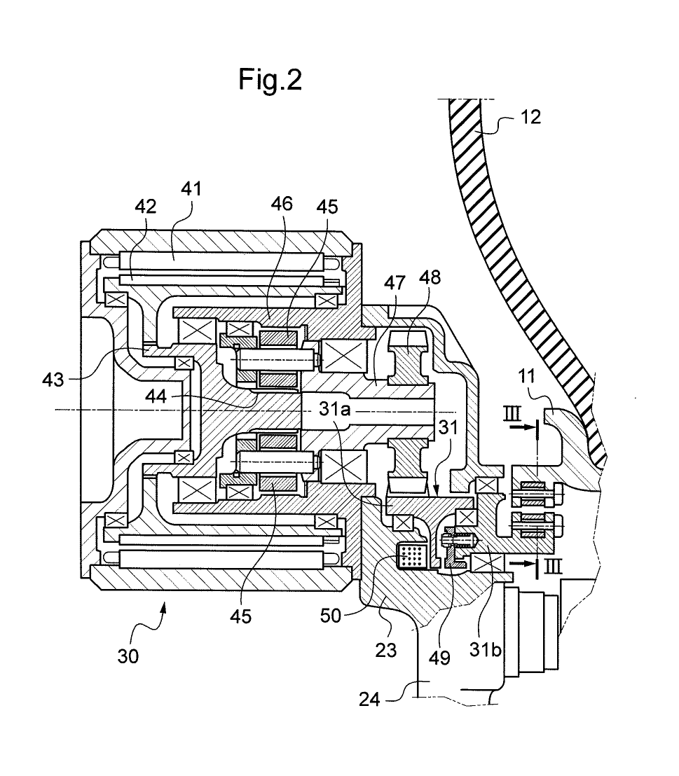

With reference to FIG. 2, the gear motor 30 comprises firstly an electric ring motor with a stator 41 and a rotor 42 mounted so as to rotate about an axis of rotation, these extending here parallel to the axis of rotation X of the associated wheel. The rotor 42 is rotationally coupled to an input shaft 43 which forms the central pinion 44 of an epicyclic reduction gear, the planet wheels 45 of which can be seen. The latter cooperate with a fixed ring 46 and are mounted on a planet-wheel carrier 47 having an output shaft which receives at its end an output pinion 48.

The output pinion 48 cooperates with the drive ring 31 so as to rotate the latter and thus rotationally drive the wheel by means of a rotational coupling device 32 according to the invention.

It will be noted here that the drive ring 31 is in fact composed of two half-rings 31a and 31b, both of which are rotationally mounted about the same axis of rotation. The half-ring 31a is rotationally driven directly by the output pinion 48. The two half-rings are rotationally mounted on the actuator holder 23 independently of each other, but may be selectively coupled together by means of a radial-tooth coupling member 49. The coupling member 49 is in the form here of a claw mounted movably on the half-ring 31b in an axial direction so as to engage with corresponding radial teeth of the half-ring 31a by means of the action of an annular electromagnet 50 extending inside the actuator holder 23.

According to the invention, the half-ring 31b is coupled to the wheel 10 by the coupling device 32 comprising a plurality of connecting members, in this case linkages 60 pivotably mounted at a first end 61 on the half-ring 31b and at a second end 62 on the rim 11.

More precisely, the half-ring 31b comprises for each linkage 60 a first cover piece 63 which receives the first end 61 of a linkage 60 so as to form a pivoted connection.

The rim 11 also comprises a second cover piece 64 which receives the second end 62 of the linkage 60 so as to form a pivoted connection.

Each connecting member extends in a direction Y (defined by the centre of the pivots) which is contained in a plane perpendicular to the axis of rotation X of the wheel.

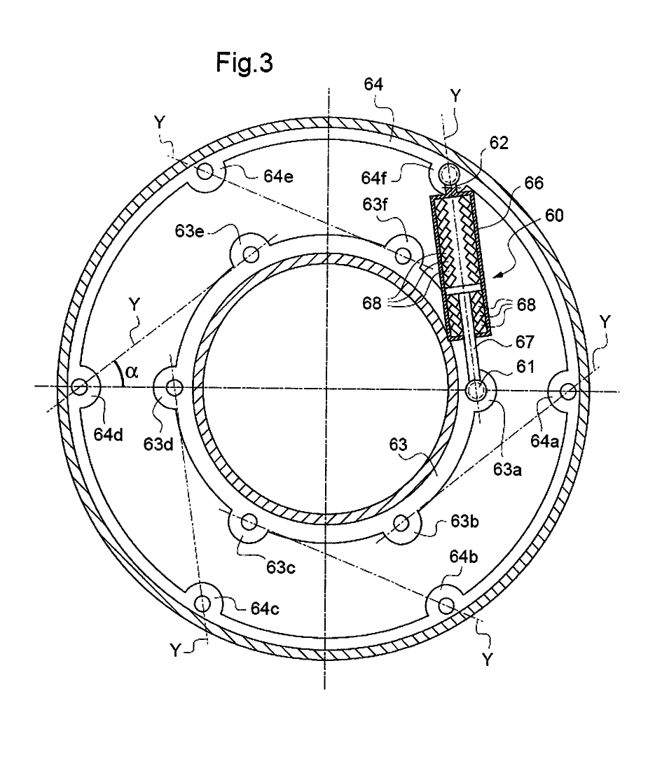

As can be seen more clearly in FIG. 3, the half-ring 31b comprises two annular flanks 63 each having six lugs 63a to 63f for receiving between them a first end 61 of a linkage 60. Only one of the flanks 63 can be seen in FIG. 3. In order to simplify the illustration in this figure, only one of the linkages 60 is shown, the other ones being simply indicated in symbol form by broken axis lines Y.

The rim 11 comprises two annular flanks 64 each with six lugs 64a to 64f for receiving the second end 62 of the linkages 60. Basically, the end pivots are connected to the lugs forming part of a cover piece by means of pins extending through the lugs and the corresponding pivot.

The linkages 60 extend along the directions Y which form an angle α with a radial direction being arranged for example between a lug 63a of the half-ring 31b and a lug 64f which is angularly offset in relation to the radial direction of the lug 63a.

Thus, when the half-ring 31b rotates in a first direction, it exerts a pulling force on the linkages which therefore rotationally drive the rim 11.

When the half-ring 31b rotates in the opposite direction, the linkages 60 are compressed and rotationally drive the rim 11.

The arrangement of the linkages 60 pivotably mounted on the drive ring 31 and on the rim 11 allows the rim 11 to enjoy two degrees of rotational freedom in relation to the ring 31. Thus, a relative angular displacement of the axis of rotation of the ring 31 and the axis of rotation of the rim 11 is possible, while allowing transmission of the rotational movement.

According to a particular feature of the invention the linkages 60 are telescopic. As shown in schematic form in FIG. 3, the linkages comprise a body 66 which is connected to the rim 11 and a rod 67 which forms a piston and is connected to the half-ring 31b and which slides inside the body 66. According to a particular embodiment, the connecting members 60 also comprise spring washers 68, in this case Belleville washers, which are arranged between the body 66 and the piston 67 so as to oppose the relative movements of the body 66 and the piston 67, namely both during traction and during compression.

The Belleville washers 68 are stacked so as to form a spring allowing the linkage 60 to modify its length while transmitting a force.

The telescopic linkages 60 allow the rim 11 to increase further the degrees of freedom which are possible in relation to the ring 31 while allowing transmission of the rotational movement. Thus, whatever the deformation of the rim 11 or the axial or angular displacement of its axis of rotation, the coupling device 32 according to the invention is able to transmit the rotational movement of the drive ring 31 to the rim 11.

The Belleville washers 68 also allow the formation of a spring, the rigidity and deformation of which may be easily modified without thereby modifying the volume of the connecting member 60. For this purpose, the washers 68 are mounted alternately so that the deformation forces are added together, in the same direction in order to increase the rigidity, or they are mounted in a mixed manner by selectively arranging the washers 68 alternately and in the same direction in order to obtain the desired rigidity and deformation.

Moreover, the Belleville washers 68 may be used to dissipate the energy, in particular when they are stacked in the same direction. In fact, when two washers 68 are stacked in the same direction, the friction produced by their respective movements dissipates a part of the energy used for their movement.

The dissipative force produced by the Belleville washers 68 is particularly advantageous because it allows jolting of the coupling device 32 during start-up to be reduced. In fact, during start-up of the drive member, the wheel is not rotationally driven immediately owing its inertia and more generally owing to the inertia of the aircraft. The drive ring 31 thus starts to oscillate about the axis of rotation and cause jolting during rotation of the wheel. In order to lessen these oscillating effects, it is therefore particularly useful to have a damping device, namely a component able to dissipate the energy of the oscillating movements.

Thus, the use of Belleville washers in the connecting members allows the generation of a resilient force and a dissipative force during relative displacement of the piston 67 and the body 66.

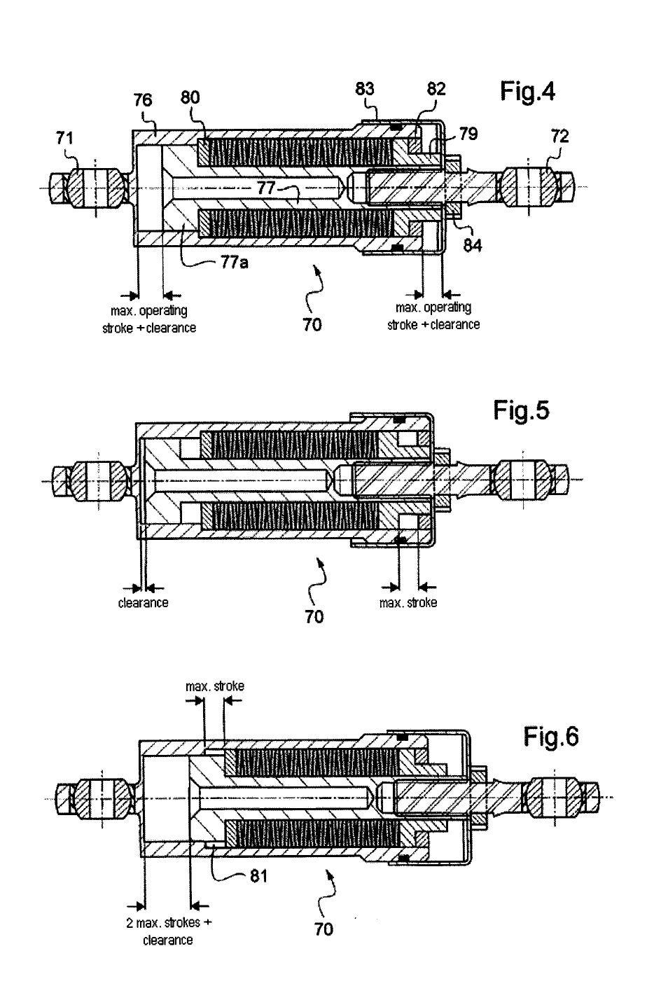

An example of embodiment of such a telescopic linkage is shown in FIGS. 4 to 6.

The linkage 70 comprises a body 76 inside which a rod 77 forming a piston 77a is slidably received. The rod 77 projects from the body and terminates in a pivoted joint 71. Belleville washers 78 are mounted around the rod so as to extend between on the one hand a sliding end-piece 79 of the body 76 bearing against a stop 82 and on the other hand a lock washer 80 bearing against a step 81 of the body when the linkage is in the rest position as shown in FIG. 4.

A cover 83 covers the end of the body 71 on the side where the sliding end-piece 79 is located, so as to protect the part of the rod 77 which slides inside the end-piece 79 and which projects from the latter during extension.

Moreover, the rod 77 comprises a lock nut 84 bearing against the stop 82. The Belleville washers 78 are thus kept permanently in the compressed state and define a rest-condition length of the linkage when the latter is no longer biased.

During compression (FIG. 5), the lock nut 84 bears against the sliding end-piece 79 so as to cause it to retract inside the body 70. During extension (FIG. 6), the piston 77a bears against the lock washer 80 so as to detach it from the step 81.

Of course, the invention is not limited to the embodiment described above, but embraces all those variations defined within the scope of the claims.

The linkages may also contain types of springs and damping devices other than Belleville washers, for example gas or oil damping devices, coupled with torsional springs.

1. A device for rotationally coupling a wheel with a ring for driving the wheel mounted so as to rotate coaxially with the wheel, the device comprising:
a plurality of connecting members each extending in a direction contained in a plane perpendicular to the axis of rotation and forming an angle with a radial direction, the connecting members being pivotably mounted, on the one hand, on the wheel and, on the other hand, on the ring, each connecting member being elastically deformable in compression and in traction along an axis that passes through its two pivot-mounted ends.

2. The device according to claim 1, wherein each connecting member has a length which varies when subject to a force acting on the connecting member in opposition to a internal dissipative force.

3. The device according to claim 2, wherein each connecting member is a telescopic linkage which comprises two sliding parts connected respectively to the wheel and to the ring, Belleville washers being arranged between the parts so as to generate a resilient and dissipative force during relative displacement of the parts.

4. Landing gear comprising at least one axle for receiving at least one wheel associated with a member for driving the wheel comprising a ring mounted so as to rotate coaxially with the wheel and connected to controlled means for rotational driving thereof, characterized in that the wheel and the ring are coupled together by a coupling device according to claim 1.
